(19) United States
(12) Patent Application Publication
(10) Pub. No.: US 2007/0186233 A1
(43) Pub. Date: Aug. 9, 2007

(54) Method for Utilizing a Media Adapter for Controlling a Display Device to Display Information of Multimedia Data Stored in a Plurality of Multimedia Sources

(76) Inventors: Shu-Yi Chen, Taipei City (TW); Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/552,528

(22) Filed: Oct. 25, 2006

(30) Foreign Application Priority Data
Feb. 8, 2006 (TW) 095104218

(51) Int. Cl. H04N 7/16

(52) U.S. Cl. 725/25

(57) ABSTRACT

A method includes: the plurality of multimedia sources respectively transmitting file information of the multimedia data stored in the plurality of multimedia sources to the media adapter; the media adapter classifying the multimedia data received from the plurality of multimedia sources according to the file information of the multimedia data to obtain a classification result; the media adapter outputting data to the display device corresponding to the classification result; and the display device displaying a frame corresponding to the classification result. The method categorizes the multimedia data so that the user can easily understand which type of category belongs to which multimedia data stored in the multimedia sources.

### BACKGROUND OF THE INVENTION

1. Field of the Invention

The present invention relates to a method for utilizing a media adapter for controlling a display device to display information of multimedia data stored in a plurality of multimedia sources, and more particularly, to a method for utilizing a media adapter for receiving file information of multimedia data transmitted from a plurality of multimedia sources, and the media adapter classifies the multimedia data according to the file information of the multimedia data received by the media adapter from the plurality of multimedia source, and the media adapter controls the display device to display a frame of the multimedia data stored in the multimedia sources corresponding to the classification result.

2. Description of the Prior Art

A characteristic of a media adapter is its ability to convert movies and image files such as media program, audio file, movie and pictures that are stored on computers, hard disks, or media servers in a wireless manner for a user to watch and listen to using traditional or digital televisions and sound systems.

Please refer to FIG. 1. FIG. 1 illustrates a diagram of a conventional media adapter 10 converting multimedia data of a plurality of multimedia sources 12 to a display device 14. The multimedia source 12 can be a computer, a hard disk, or a media service. The multimedia stored in the multimedia source 12 can be a media program, an audio file, a movie, or a picture, and the display device 14 can be a television. The multimedia source 12 can transmit the multimedia data stored in the multimedia source 12 to the media adapter 10 in a wired or wireless manner. The media adapter 10 can be utilized for decoding the multimedia data transmitted from the plurality of multimedia sources 12 to generate signals receivable by the display device 14. The signals are then transmitted to the display device 14 in a wired or wireless manner where after the user can listen and watch the multimedia data on the display device 14.

However, considering the aspect of the conventional media adapter 10 controlling the display device 14 to display a data list of the multimedia data stored in the multimedia source 12, firstly the media adapter 10 will search through the plurality of multimedia sources 12 to determine which multimedia source 12 are already linked with the media adapter 10, then the user can select the multimedia source 12 linked with the media adapter 10 through the media adapter 10. Next, the media adapter 10 will request the multimedia source 12 selected by the user to transmit file information of the multimedia data stored in the multimedia source 12 to the media adapter 10. The media adapter 10 will then output data corresponding to the file information to the display device 14 so that the display device 14 displays a data list corresponding to the multimedia data. Thus, this method is restrictive whereby it allows the user to select a data list of multimedia data of a predetermined multimedia source 12 through the media adapter 10, but does not allow a full data list of the multimedia data of the multimedia data stored in the multimedia source 12. Also, classification of the data list of the multimedia data obtained from the predetermined multimedia source 12 is not performed. Hence, this method of displaying a data list of the multimedia data stored in the multimedia source 12 is not conventional or innovative.

### SUMMARY OF THE INVENTION

The claimed invention discloses a method for utilizing a media adapter for controlling a display device to display information of multimedia data stored in a plurality of multimedia sources. The method comprises the plurality of multimedia sources respectively transmitting file information of the multimedia data stored in the plurality of multimedia sources to the media adapter; the media adapter classifying the multimedia data according to the file information of the multimedia data received in the above-mentioned step; the media adapter outputting, to the display device, data corresponding to a classification result of the above-mentioned step; and the display device displaying a frame corresponding to the classification result.

The claimed invention discloses a media adapter capable of controlling a display device to display information of multimedia data stored in a plurality of multimedia sources. The media adapter comprises a receiving module for receiving file information of the multimedia data transmitted from the plurality of multimedia sources; a control device, coupled to the receiving module, for classifying the multimedia data according to the file information of the multimedia data received by the receiving module; and an output module, coupled to the control device, for outputting a data, to the display device, corresponding to a classification result generated by the control device so that the display device is capable of displaying a frame corresponding to the classification result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a conventional media adapter converting multimedia data of a plurality of multimedia sources to a display device.

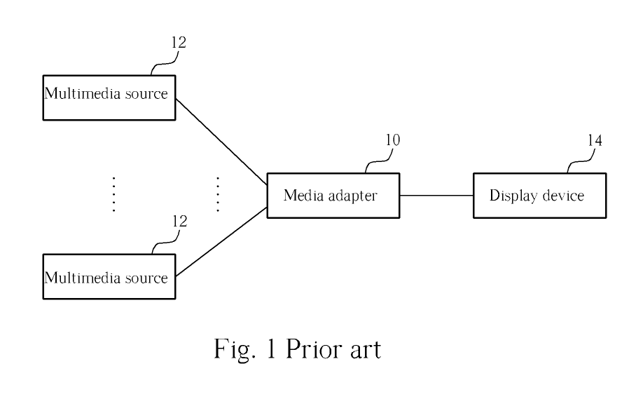

FIG. 2 illustrates a functional block diagram of a media adapter converting multimedia data stored in a plurality of multimedia sources to a display device according to the present invention.

FIG. 3 illustrates a flowchart of utilizing a media adapter for controlling a display device to display a data list of multimedia data stored in a plurality of multimedia sources.

FIG. 4 illustrates a diagram of file information of multimedia data provided by a multimedia source.

FIG. 5 illustrates a diagram of a classification result of the multimedia data.

FIG. 6 illustrates a diagram of the display device displaying a selection made by a user to view the data list of the multimedia data corresponding to FIG. 5 that belongs to a frame of multimedia data of a general rating category.

FIG. 7 illustrates a diagram of the display device displaying a selection made by a user to view the data list of the multimedia data corresponding to FIG. 6 that belongs to a frame of multimedia data of a general rating category and MP3 file format.

### DETAILED DESCRIPTION

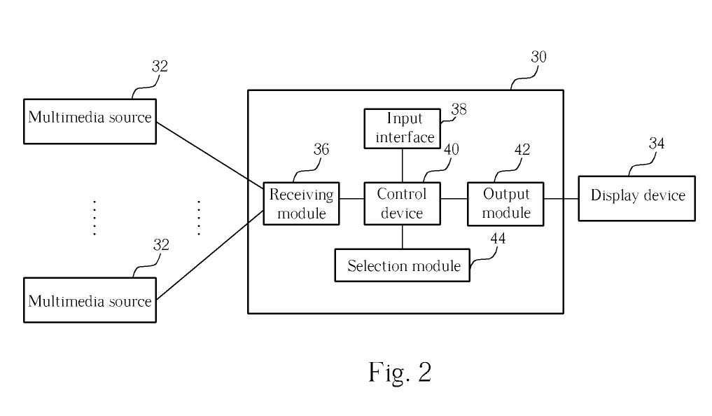

Please refer to FIG. 2. FIG. 2 illustrates a functional block diagram of a media adapter 30 converting multimedia data stored in a plurality of multimedia sources 32 to a display device 34. The multimedia source 32 can be a computer, a hard disk, or media service. The multimedia stored in the multimedia source 32 can be a media program, an audio file, a movie, or a picture. The display device 34 can be a television. The media adapter 30 includes a receiving module 36 for receiving file information of multimedia data and the multimedia data transmitted from the plurality of multimedia sources 32, wherein the receiving module 36 can receive the data transmitted from the plurality of multimedia sources 32 in a wired or wireless manner. The media adapter 30 further includes an input interface 38 for a user to input a user access data; a control device 40, which is coupled to the receiving module 36 and the input interface 38, is utilized for classifying the multimedia data according to the file information of the multimedia data received by the receiving module 36, the control device 40 can be presented in a hardware or a software format; an output module 42, which is coupled to the control device 40, is utilized for outputting a data corresponding to a classification result generated by the control device 40 to the display device 34 so that the display device displays a frame corresponding to the classification result; and a selection module 44 is utilized for inputting a selection signal to the control device 40 so that the control device 40 controls the output module 42 to output the classification result corresponding to the selection signal to the display device 34, wherein the selection module 44 can be an on screen display (OSD) or a remote controller. The multimedia source 32 can transmit the multimedia data stored in the multimedia source 32 to the receiving module 36 of the media adapter 30 through a wired or wireless manner. The media adapter 30 is capable of decoding the multimedia data transmitted from the plurality of multimedia sources to generate signals receivable by the display device 34, and the output module 42 is utilized to transmit the signals to the display device 34 through a wired or wireless manner such that the user can listen and watch multimedia data on the display device 34.

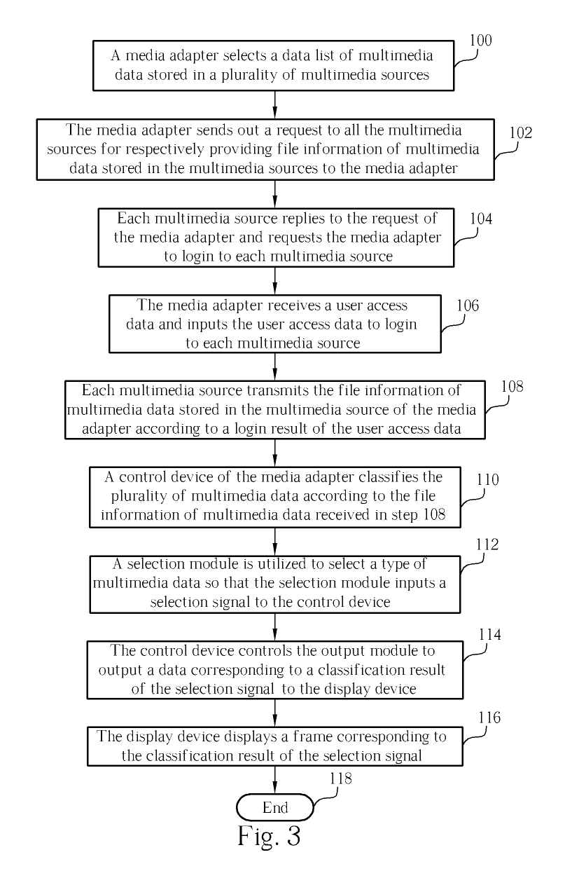

Please refer to FIG. 3. FIG. 3 illustrates a flowchart of utilizing a media adapter 30 for controlling a display device 34 to display a data list of multimedia data stored in a plurality of multimedia sources 32. The method includes the following steps:

Step 100: select a data list of multimedia data stored in a plurality of multimedia sources 32 through a media adapter 30;

Step 102: the media adapter 30 sends out a request to all the multimedia sources 32 for respectively providing file information of multimedia data stored in the multimedia sources 32 to the media adapter 30;

Step 104: each multimedia source 32 replies to the request of the media adapter 30 and requests the media adapter 30 to login to each multimedia source 32;

Step 106: the media adapter 30 receives a user access data and inputs the user access data to login to each multimedia source 32;

Step 108: each multimedia source 32 transmits the file information of multimedia data stored in the multimedia source 32 to the media adapter 30 according to a login result of the user access data;

Step 110: a control device 40 of the media adapter 30 classifies the plurality of multimedia data according to the file information of multimedia data received in step 108;

Step 112: a selection module 44 is utilized to select a type of multimedia data so that the selection module 44 inputs a selection signal to the control device 40;

Step 114: the control device 40 controls the output module 42 to output a data corresponding to a classification result of the selection signal to the display device 34;

Step 116: the display device 34 displays a frame corresponding to the classification result of the selection signal;

Step 118: end.

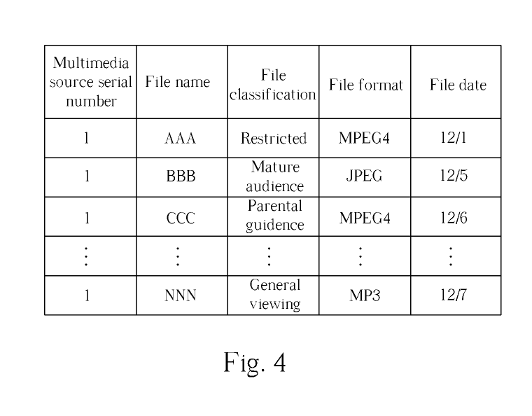

The following is provided to further explain the above-mentioned steps. Firstly, a user, for example, selects a data list of multimedia data stored in a plurality of multimedia sources 32 through a media adapter 30, then the media adapter 30 will send out a request to all of the multimedia sources 32 for respectively providing, to the media adapter 30, file information about the multimedia data stored in the multimedia sources 32. For example, please refer to FIG. 4. FIG. 4 illustrates a diagram of the file information of the multimedia data provided by a multimedia source 32. The file information includes a serial number of the multimedia source 32, a file name information of the multimedia data, a file classification information of the multimedia data, a file format information of the multimedia data, and a file date information of the multimedia data. Please note that a different multimedia source 32 will generate a different specific file information of the multimedia data. Next, each multimedia source 32 will reply to the request of the media adapter 30 and request the media adapter 30 to login to each multimedia source. In other words, if the multimedia source 32 has restriction access enabled, then the media adapter 30 has to comply with the user name and password of the restriction setting in order to login to the multimedia source 32 to obtain the specific file information of the multimedia data of the multimedia source 32. For example, the user can input a user access data by utilizing the input interface 38, and after the media adapter 30 receives the user access data inputted by the user, the media adapter 30 would login to each multimedia source 32 according to the user access data. Next, each multimedia source 32 transmits the file information of the multimedia data stored in the multimedia source 32 to the media adapter 30 according to a login result of the user access data, where each multimedia source 32 can set a different user access data, thus a user access data of a certain multimedia source 32 will be compliant to the user access data of the media adapter 30, whereas a user access data of another certain multimedia source 32 will not be compliant to the user access data of the media adapter 30. After the media adapter 30 has managed a successful login to a multimedia source 32, the corresponding multimedia source 32 will transmit its file information of the multimedia data to the media adapter 30; however, if the media adapter 30 failed to login successfully to a multimedia source 32, the corresponding multimedia source 32 will not transmit its file information of the multimedia data to the media adapter, or alternatively, the multimedia source 32 can provide only limited file information.

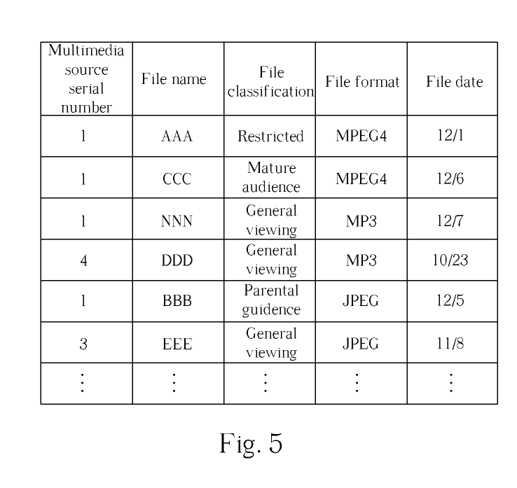

After the receiving module 36 of the media adapter 30 receives the file information of the multimedia data transmitted from each multimedia source 32, the control device 40 of the media adapter 30 will begin to classify the plurality of multimedia data according to the file information of the multimedia data received by the receiving module 36. In other words, the control device 40 begins to classify the multimedia data corresponding to the current file information. For example, please refer to FIG. 5 for further illustration. FIG. 5 illustrates a diagram of a classification result of the multimedia data. In this example, the control device 40 continues to classify the plurality of multimedia data according to the file format information of the multimedia data. Specifically, the multimedia data having file names AAA and CCC of a video file format that is the MPEG4 format belongs to a same group. Additionally, multimedia data having file names NNN and DDD of the audio file format that is the MP3 format belongs to a same group. Finally, multimedia data having file names BBB and EEE of the graphic file format that is the JPEG format belongs to a same group. Additionally, the control device 40 can classify the plurality of multimedia data according to other information of the multimedia data, such as a serial number of the multimedia source 32, a file name information of the multimedia data, a file classification information of the multimedia data, and a file date information of the multimedia data. The classification operation is the same hence the details will not be reiterated. When the file information of the same multimedia data file name is transmitted from the different multimedia source 32, the name and the serial number of the multimedia source 32 corresponding to the file name of the multimedia data can be placed first in order to differentiate the various multimedia data.

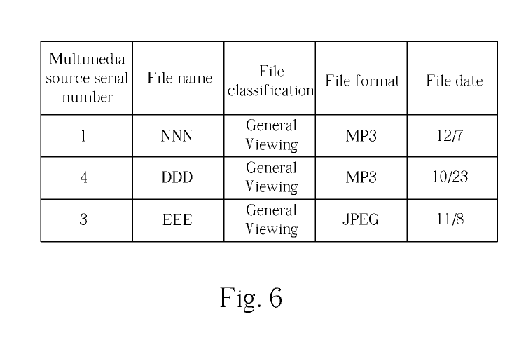

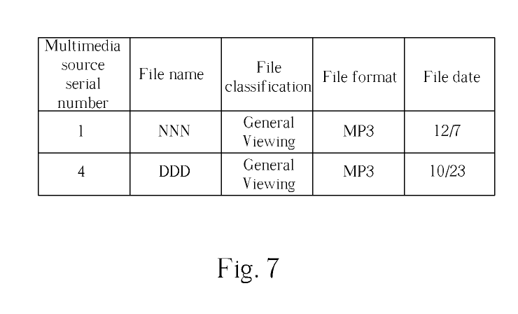

Next, the user can utilize the selection module 44 to select the category of the multimedia data to be enjoyed. For example, the user can choose to view a data list of the multimedia data of the full category by making the appropriate selection. In another case, the user can choose to view only a data list of a specific file format. For example, the user may desire to only view a data list of multimedia data of MPEG4 file format. The selection module 44 can set a hot key or an on-screen display (OSD) mode to facilitate the user in selecting the corresponding multimedia category. Next, the selection module 44 will input a corresponding selection signal to the control device 40. The control device 40 can control the output module 42 to output a data to the display device 34 corresponding to a classification result of the selection signal so that the display device 34 displays a frame corresponding to the classification result of the selection signal. For example, please refer to FIG. 6 for further illustration. FIG. 6 illustrates a diagram of the display device 34 displaying a selection made by a user to view the data list of the multimedia data that belongs to a frame of multimedia data of a general rating category corresponding to FIG. 5. When the user selects to view a data list of the multimedia data of the general rating category through the selection module 44, the selection module 44 will input a selection signal to the control device 40 corresponding to the general rating category, and the control device 40 can control the output module 42 to output a data to the display device 34 corresponding to a classification result of the selection signal of the general rating category so that the display device 34 displays a frame corresponding to the classification result of the selection signal of the general rating category, thus in this frame, the user can only view the classification result being performed on the multimedia data of the general rating category according to the file format information of the multimedia data. Please refer to FIG. 7. FIG. 7 illustrates a diagram of the display device 34 displaying a selection made by a user to view the data list of the multimedia data that belongs to a frame of multimedia data of a general rating category and MP3 file format corresponding to FIG. 6. When the user selects through the selection module 44 to view a data list of the multimedia data of the general rating category, the user further utilizes the selection module 44 to select and view a data list of multimedia data of MP3 file format. For example, this can be achieve by the user pressing a hot key corresponding to the MP3 file format. At this time the control device 40 can control the output module 42 to output to the display device 34 a data corresponding to a classification result of the selection signal of the general rating category and the MP3 file format so that the display device 34 displays a frame corresponding to the classification result of the selection signal of the general rating category and the MP3 file format, thus in this frame, the user can only view the classification result of the multimedia data of the general rating category and the MP3 file format.

In comparison to the conventional method of the media adapter controlling the display device to display the data list of the multimedia data stored in the multimedia sources and the media adapter, the method of the present invention utilizes a media adapter for receiving file information of multimedia data transmitted from a plurality of multimedia sources, and then the media adapter classifies the multimedia data according to the file information of the multimedia data received so as to control the display device to display a frame of the multimedia data stored in the multimedia sources according to the classification result and the media adapter. Thus, the present invention can display the data list of the multimedia data after a classification operation on the display device. The user can easily understand which type of category belongs to which multimedia data stored in the multimedia sources, this allows a selection of multimedia data to be easily heard or viewed. Hence, the present invention provides an innovative multimedia user interface for the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for utilizing a media adapter for controlling a display device to display information of multimedia data stored in a plurality of multimedia sources, the method comprising:
(a) the plurality of multimedia sources respectively transmitting file information of the multimedia data stored in the plurality of multimedia sources to the media adapter;
(b) the media adapter classifying the multimedia data according to the file information of the multimedia data received in step (a);
(c) the media adapter outputting data corresponding to a classification result of step (b) to the display device; and
(d) the display device displaying a frame corresponding to the classification result.

2. The method of claim 1 further comprising the media adapter requesting the plurality of multimedia sources to transmit the file information of the multimedia data stored in the plurality of multimedia sources to the media adapter.

3. The method of claim 1 further comprising the media adapter logging in to the plurality of multimedia sources according to received user access data.

4. The method of claim 3 wherein step (a) comprises the plurality of multimedia sources transmitting the file information of the multimedia data stored in the plurality of multimedia sources to the media adapter according a login result of the user access data.

5. The method of claim 1 wherein step (a) comprises the plurality of multimedia sources respectively transmitting file format information of the multimedia data stored in the plurality of multimedia sources to the media adapter, and step (b) comprises the media adapter classifying the multimedia data according to the file format information of the multimedia data received in step (a).

6. The method of claim 1 wherein step (a) comprises the plurality of multimedia sources respectively transmitting file classification information of the multimedia data stored in the plurality of multimedia sources to the media adapter, and step (b) comprises the media adapter classifying the multimedia data according to the file classification information of the multimedia data received in step (a).

7. The method of claim 1 wherein step (a) comprises the plurality of multimedia sources respectively transmitting file date information of the multimedia data stored in the plurality of multimedia sources to the media adapter, and step (b) comprises the media adapter classifying the multimedia data according to the file date information of the multimedia data received in step (a).

8. A media adapter capable of controlling a display device to display information of multimedia data stored in a plurality of multimedia sources, the media adapter comprising:
a receiving module for receiving file information of the multimedia data transmitted from the plurality of multimedia sources;
a control device coupled to the receiving module for classifying the multimedia data according to the file information of the multimedia data received by the receiving module; and
an output module coupled to the control device for outputting data corresponding to a classification result generated by the control device to the display device so that the display device is capable of displaying a frame corresponding to the classification result.

9. The media adapter of claim 8 further comprising an input interface for inputting user access data.

10. The media adapter of claim 8 further comprising a selection module for inputting a selection signal to the control device so that the control device is capable of controlling the output module to output data of a class selected by the selection signal to the display device.

11. The media adapter of claim 10 wherein the selection module is a remote controller.

12. The media adapter of claim 10 wherein the selection module is an on screen display (OSD).

13. The media adapter of claim 8 wherein one of the multimedia sources is a computer.

14. The media adapter of claim 8 wherein one of the multimedia sources is a DVD player.
